(19) United States
(12) Patent Application Publication
(10) Pub. No.: US 2008/0180718 A1
(43) Pub. Date: Jul. 31, 2008

(54) CLIENT SERVER SYSTEM AND IMAGE FORMING APPARATUS

(75) Inventor: Takashi Yamashita, Mishima-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/626,926

(22) Filed: Jan. 25, 2007

(51) Int. Cl. G06F 3/12; G06F 15/16

(52) U.S. Cl. 358/1.15; 709/203

(57) ABSTRACT

The invention provides an image forming apparatus connectable to a server via a network. The image forming apparatus includes a network controller for connecting the image forming apparatus to the network and a control unit capable of executing check processing for a server. At the time of the check processing for the server, the control unit transmits a connection request packet (SYN) to the server and performs port scan. The control unit checks a state of the server according to presence or absence of a response (ACK) from the server. When there is no response, the control unit reports a connection error to a user after elapse of an arbitrary timeout period set in the image forming apparatus.

### BACKGROUND OF THE INVENTION

1. Field of the Invention

The present invention relates to a client server system in which clients and a server are connected via a network. The present invention also relates to an image forming apparatus such as an MFP (Multi-Function Peripherals), which is a digital complex machine, or a copying machine.

2. Description of the Related Art

In general, among image forming apparatuses such as an MFP and a copying machine, there are image forming apparatuses that have plural functions such as a copy function and a scan function. Such image forming apparatuses (e.g., an MFP) are connectable to a server and external apparatuses such as a PC (Personal Computer) via a network. Some image forming apparatuses have a network print function, a mail function, and the like other than the printer function and the scan function.

The network print function is a function of printing image data, which is sent from an external apparatus (e.g., a PC) to the MFP, on the MFP side. The mail function is a function of transmitting image data or the like, which is scanned by the MFP, to the PC in a form of an Email.

When the MFP is a client, the server connected to the network executes various kind of processing in response to a request from the client and operates in cooperation with the client. As the server, there are, for example, a mail server, a web server, and a printer server.

In a general client server system, in checking whether a server is present or the server functions normally, a client (an MFP) can check whether the server is present or the server functions normally by sending a connection request to the server and waiting for a response from the server.

For example, when the client sends a connection request to the server and there is no response from the server even if a predetermined timeout period has elapsed, the client can confirm that the server is not present or the server does not function normally.

As a network protocol, the TCP/IP (Transmission Control Protocol/Internet Protocol) is typically used. As applications that use the TCP/IP, mail servers of SMTP, POP3, and the like and web servers of HTTP, LDAP, and the like are known. On the other hand, specifications of the applications of mails and webs that use the TCP/IP are issued according to an RFC (Request For Comments). It is recommended that the timeout period is set to 2 minutes.

Therefore, in making connection to the server, when the server is not present, in general, the client determines occurrence of a connection error after the timeout period (2 minutes) defined in the RFC elapses. In some products, on a client side, a timeout value is set shorter than 2 minutes defined in the RFC and a timeout period of 30 seconds to 1 minute is set taking into account a delay in a response.

Since the timeout period is determined in this way in the past, when the server is not present, there is no response from the server to the client, the client comes into a state of wait for a response, and processing is stopped during the timeout period (2 minutes). Even if a timeout value is set short on the client side, since there is no response for 30 seconds to 1 minute, it looks as if the machine freezes.

In an international patent publication WO 02/098085 A1, an Internet communication system is described. In this example, the internet communication system includes plural session management servers and each of the session management servers manages plural communication adapters and plural communication relay adapters. Consequently, processing loads on the respective session management servers are uniformalized to improve operation efficiency of the system.

In this example, communication processing of the TCP is also described. It is mentioned that a timeout value is provided in making connection from a client to a server and, when a waiting time exceeding the timeout value occurs, the connection is made again. However, in the examples described above, a timeout period is long.

The present invention provides a client server system and an image forming apparatus that can immediately check presence of a server.

### DESCRIPTION OF THE DRAWING

FIG. 1 is a network diagram showing a client server system of the invention;

FIG. 2 is a block diagram showing a structure of a first embodiment of an image forming apparatus of the invention;

FIG. 3 is a sequence chart for explaining an operation of check processing for a server in the image forming apparatus of the invention;

FIG. 4 is a sequence chart for explaining another operation of the check processing for the server in the image forming apparatus of the invention; and

FIG. 5 is an explanatory diagram showing an example of display in an operation unit in the image forming apparatus of the invention.

### DETAILED DESCRIPTION OF THE INVENTION

Throughout this description, the embodiment and example shown should be considered exemplars, rather than limitations on the apparatus and systems of the present invention.

An embodiment of the invention will be hereinafter explained in detail with reference to the drawings. In the respective figures, identical components are denoted by identical reference numerals and signs.

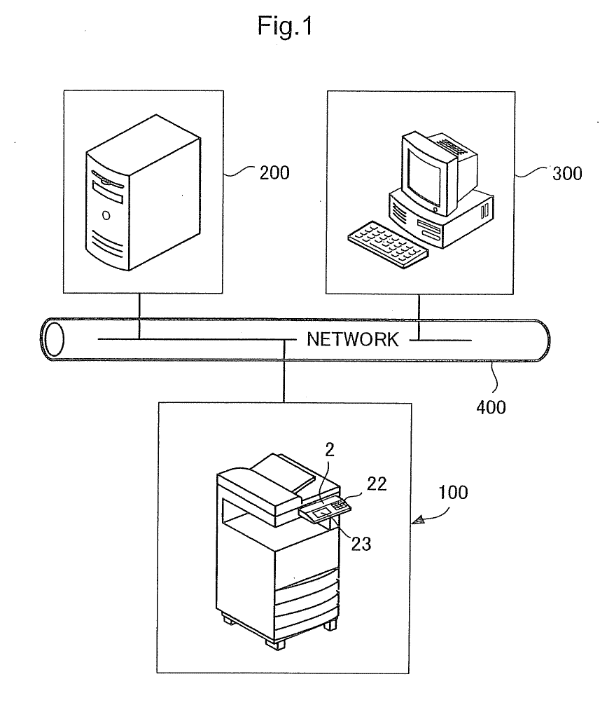

FIG. 1 is a network diagram showing a client server system that uses an image forming apparatus according to the embodiment of the invention.

In the system in FIG. 1, an image forming apparatus 100 is, for example, an MFP (Multi Function Peripherals), which is a digital complex machine. This image forming apparatus 100 is connectable to a server 200 and a terminal 300 such as a PC (Personal Computer) via a network 400 such as an LAN (Local Area Network).

In an example explained below, an MFP (Multi-function Peripherals) is used as the image forming apparatus 100. However it is also possible to apply the invention to a copying machine and other image forming apparatuses. The MFP 100 has an operation unit 2. Various operation keys 22 and a display device 23 made of liquid crystal or the like are provided in the operation unit 2.

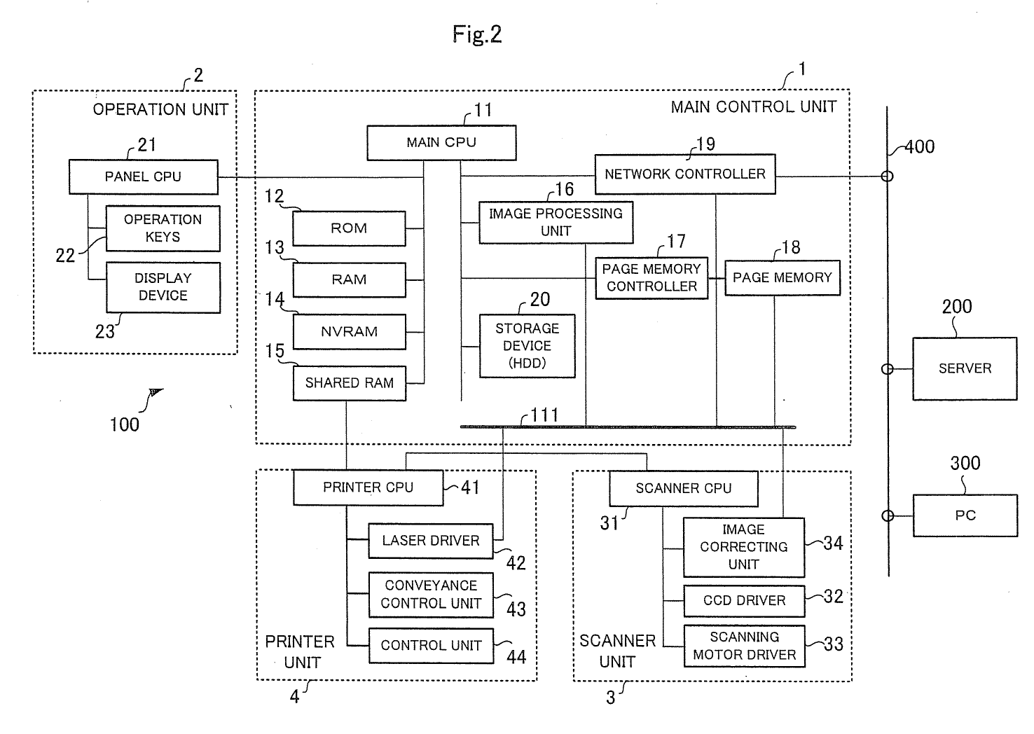

FIG. 2 is a block diagram showing a structure of the image forming apparatus 100 of the invention. In FIG. 2, the MFP 100 is connectable to the server 200 and the PC 300 via the network 400 such as the LAN (Local Area Network).

The MFP 100 has a main control unit 1, an operation panel 2, a scanner unit 3, and a printer unit 4. A control system of the MFP 100 is constituted by plural CPUS, namely, a main CPU 11 in the main control unit 1, a panel CPU 21 of the operation unit 2, a scanner CPU 31 of the scanner unit 3, and a printer CPU 41 of the printer unit 4.

The main control unit 1 includes the main CPU 11, a ROM (Read Only Memory) 12, a RAM 13, an NVRAM 14, a shared RAM 15, an image processing unit 16, a page-memory control unit 17, a page memory 18, a network controller 19, and an HDD 20 serving as a storage device. Reference numeral 111 denotes an image data bus.

The main CPU 11 controls an overall operation of the MFP 100. A control program and the like are stored in the ROM 12. The RAM 13 temporarily stores data. The NVRAM 14 is a nonvolatile memory and holds stored data even if a power supply is isolated. The shared RAM 15 is used for performing bidirectional communication between the main CPU 11 and the printer CPU 41.

The page-memory control unit 17 stores image information in and reads out information from the page memory 18. The page memory 18 has an area in which it is possible to store image information for plural pages and is capable of storing, for each page, data obtained by compressing the image information from the scanner unit 3.

The network controller 19 is connected to the network 400. The MFP 100 is connected to the server 200 and the PC 300 via the network controller 19.

The HDD 20 compresses and stores data scanned by the scanner unit 3 and image data (document data, rendered image data, etc.) from the PC 300. The image data stored in the HDD 20 is processed and subjected to various kinds of image processing by the image processing unit 16 and printed on a sheet by the printer unit 4.

The operation unit 2 has the panel CPU 21 connected to the main CPU 11, the various operation keys 22, and the display device 23 made of liquid crystal or the like. The operation keys 22 are keys for inputting various instructions such as the number of prints and a print size. The display device 23 has a touch panel function other than performing various kinds of display.

The scanner unit 3 includes the scanner CPU 31 that controls operations of a scanner, a CCD driver 32 that drives a color image sensor, a scanning motor driver 33 that controls rotation of a scanning motor, and an image correcting unit 34. The CCD driver 32 illuminates an original placed on an original stand with an exposure lamp, receives reflected light of the original with a CCD to scan an image of the original, and converts the image into image data.

The image correcting unit 34 includes an A/D conversion circuit that converts analog signals of R, G, and B outputted from the color image sensor into digital signals, respectively, a shading correction circuit, and a line memory that temporarily stores a corrected digital signal from the shading correction circuit.

The printer unit 4 has the printer CPU 41 that controls operations of the printer unit, a laser driver 42 that drives a laser, a conveyance control unit 43 that controls conveyance of sheets, and a control unit 44 that controls a charging device, a developing device, and a transfer device.

The main CPU 11 performs bidirectional communication with the printer CPU 41 via the shared RAM (Random Access Memory) 15. The main CPU 11 issues an operation instruction and the printer CPU 41 returns a status. The printer CPU 41 and the scanner CPU 31 perform serial communication. The printer CPU 31 issues an operation instruction and the scanner CPU 41 returns a status.

The image processing unit 16, the page memory 18, the network controller 19, the image correcting unit 34, and the laser driver 42 are connected by the image data bus 111.

The MFP 100 and the server 200 are connected via the network 400. As a network protocol, for example, the TCP/IP (Transmission Control Protocol/Internet Protocol) is used.

The server 200 has, for example, functions of a mail server and a web server as applications that use the TCP/IP. As the mail server function, the server 200 has a mail delivery function according to the SMTP (Simple Mail Transfer Protocol) and a download function according to the POP3 (Post Office Protocol 3).

As the web function, the server 200 has a home page release function according to the HTTP (Hyper Text Transfer Protocol) and a domain management function according to the LDAP (Lightweight Directory Access Protocol).

The MFP 100 can access the server 200 via the network controller 19 under the control by the main CPU 11 and can use the mail function and the web function held by the server 200. The MFP 100 can execute check processing for the server 200 under the control by the main CPU 11.

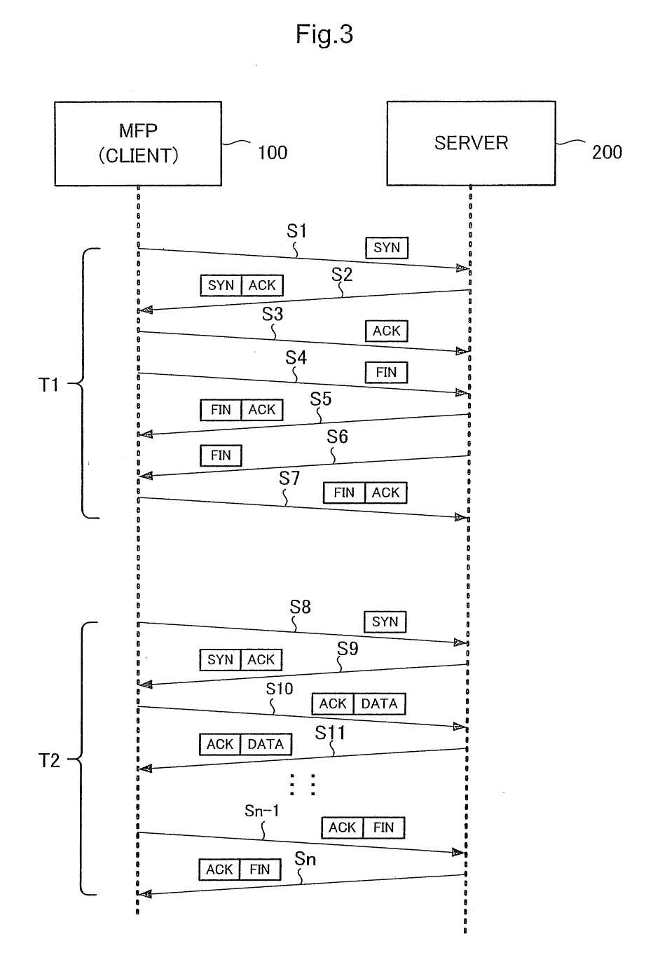

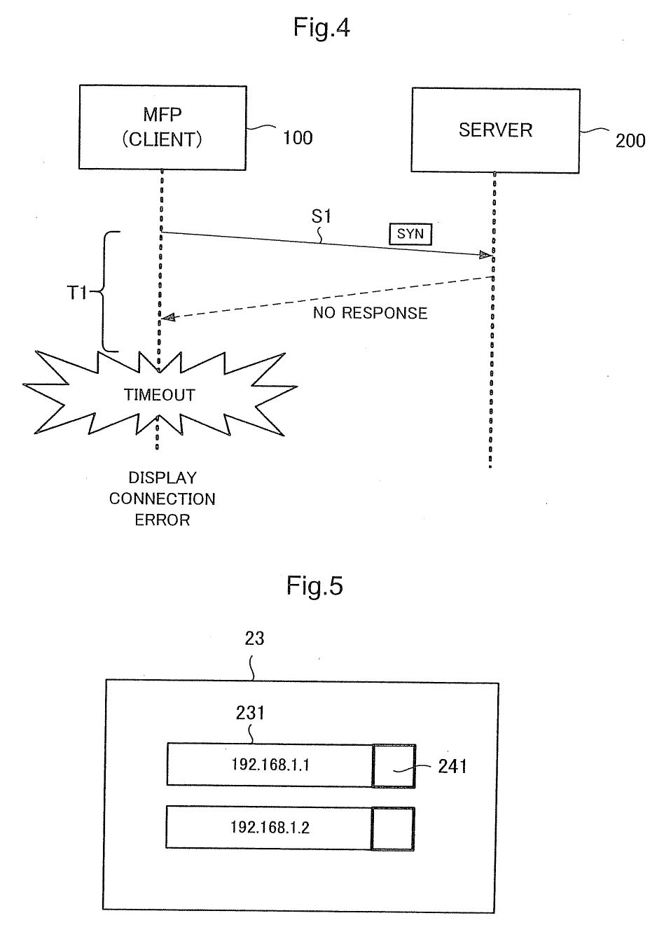

Characteristics of the invention will be explained with reference to FIGS. 3 and 4. In the following explanation, the MFP 100 may be explained as a client and may be referred to as the client 100.

The invention has a characteristic in that, in connecting the MFP 100 to the server 200, it is possible to perform check processing for the server 200. In other words, it is possible to check in a short time, by checking whether a target service port is open, whether the server 200 is present or the server 200 functions normally. In the following explanation, the checking on whether the target service port is open is referred to as port scan.

In the TCP protocol, in performing communication between a client and a server, data is transmitted and received while checking whether the data has correctly reached a partner side using an SYN packet, an ACK, and a FIN packet present in a TCP header. The SYN packet indicates a connection request, the ACK indicates acknowledgment, and the FIN packet indicates a connection end.

In a normal communication state, communication is performed using the SYN packet, the ACK, and the FIN packet. However, the invention has a characteristic in that, in performing check processing for the server 200, the SYN packet is transmitted from the client 100 to check whether a server is present and whether a service port of the server 200 is open.

In transmitting and receiving data using the TCP/IP, since plural applications are operating in the server 200, ports from 1 to 65535 are set in a communication network and communication is performed to prevent data of the application from being mixed.

These ports are called service ports. For example, a port number of an SMTP protocol used for mail transmission is 25, a port number of a POP 3 is 110, a port number of an HTTP protocol used in a web is 80. The server 200 waits for connection from the client 100 to provide a service using the port numbers and the protocols of the port numbers.

Therefore, in performing the check processing for the server 200, first, the SYN packet is transmitted from the client 100 to check presence of the server 200 and whether the service port of the server 200 is open.

FIG. 3 is a diagram showing a communication state between the client 100 and the server 200 in the case in which the server 200 is present. In FIG. 3, a left space indicates the client 100 and a right space indicates the server 200. Communication states between the client 100 and the server 200 are shown in time series.

Steps S1 to S7 indicate steps of check processing T1 for a server. First, in step S1, the client 100 transmits an SYN packet to the server 200 and checks whether the service port (e.g., when a protocol is a protocol of the SMTP of mail transmission, a port number is 25) of the server 200 is opened.

When the server 200 is present and the target service port is open, in step S2, in order to notify that the SYN packet is received, the server 200 returns the SYN packet and an ACK to the client 100.

In step S3, in order to notify that the ACK from the server 200 is received, the client 100 transmits an ACK to the server 200. In step S4, the client 100 transmits a FIN packet indicating the end of connection to the server 200.

In step S5, in order to notify that the FIN packet is received, the server 200 returns the FIN packet and an ACK to the client 100. In step S6, the server 200 transmits the FIN packet to the client 100.

In step S7, in order to notify that the FIN packet is received, the client 100 returns the FIN packet and an ACK to the server 200. The check processing T1 for the server 200 is finished.

These kinds of processing in steps S1 to S7 are set to be finished with timeout of about 1 to 2 seconds regardless of a timeout period (2 minutes) of the TCP. Usually, since the ACKs for the SYN packet and the FIN packet are returned in about 200 msec, it is easy to set the processing in timeout of about 1 to 2 seconds.

When the check processing for the server (steps S1 to S7) is finished, normal communication processing T2 is started.

The normal communication processing T2 includes steps S8 to Sn. In step S8, the client 100 transmits an SYN packet to the server 200. In step S9, the server 200 returns the SYN packet and an ACK to the client 100 in order to notify that the SYN packet is received.

In step S10, the client 100 transmits an ACK and transmission data to the server. In order to notify reception of the transmission data, the server 200 returns an ACK and the data to the client 100. Thereafter, the client 100 and the server 200 perform transmission and reception of the data each other while checking whether the data has correctly reached the partner sides.

Finally, as indicated by step Sn-1, the client 100 transmits a FIN packet. In step Sn, in response to the transmission of the FIN packet, the server 200 returns the FIN packet and an ACK. Then, the communication is finished.

When the client 100 and the server 200 perform communication each other, sequence numbers are attached to the SYN packets, the ACKs, the FIN packets, and the like and, in response, the SYN packets, the ACKs, the FIN packets are returned with response numbers attached thereto such that the communication is performed in good order.

FIG. 4 is a sequence chart showing a communication state between the client 100 and the server 200 in the case in which the target service port of the server 200 is not open.

First, in step S1, the client 100 transmits an SYN packet to the server 200 and checks whether the service port of the server 200 is open.

When the server 200 is not present, when the server 200 does not function normally, or when the target port of the server 200 is not open, no response is transmitted from the server 200.

In this way, when no response is returned from the server 200 even if the SYN packet is transmitted for server check, after an arbitrary timeout period (e.g., 1 to 2 seconds), the client 100 determines that the server 200 is not present and processes this state as a connection error.

The arbitrary timeout period (1 to 2 seconds) is set regardless of the timeout period (2 minutes) of the TCP. For example, the arbitrary timeout period is set to timeout of the same degree as the timeout (about 1 to 2 seconds) set for the server check processing (T1) in FIG. 3. This makes it possible to check a state of the server 200 in a short time.

FIG. 5 shows an example of display in the display device 23 of the MFP 100 at the time when the check processing for the server is performed.

In FIG. 5, reference numeral 231 denotes an IP address of a target server and 241 denotes a check button. Since the display device 23 has a function of a touch panel, it is possible to execute check processing for the server 200 by touching the check button 241.

Supplementing the explanation, a hierarchical model of the TCP/IP includes an application layer (HTTP, SMTP, POP3, etc.), a transport layer (TCP, UDP), an internet layer (IP), and a network interface layer. In FIG. 5, only an address and a port are checked in the internet layer (the IP layer) immediately below the transport layer to check a destination and check whether a target server opens a service port thereof.

For example, when the server 200 is a mail server, after checking the IP address 231 displayed on the display device 23, a user presses the check button 241. This makes it possible to check whether the server 200 is in a state in which the server 200 can receive a mail.

On the other hand, when the server 200 is in a state in which the server 200 cannot receive a mail, since there is no response from the server 200, when the timeout (1 to 2 seconds) set in advance elapses, a message of a connection error is displayed on the display device 23. Therefore, the user can check the connection error in a short time without waiting for the timeout period (2 minutes) defined in the RFC.

When there are plural servers 200, plural IP addresses 231 and plural check buttons 241 only have to be displayed to allow the user to select any one of the IP addresses 231 and the check buttons 241.

In this way, according to the image forming apparatus of the invention, when the client 100 performs check processing for the server, if no response is returned from the server 200, for example, if the server 200 is not present, it is possible to immediately check a connection error. Therefore, it is possible to prevent processing from being stopped for a long period until the checking. Consequently, for example, when some failure occurs in the server and the server is down, the user can immediately learn the connection error and is not kept waiting for an unnecessary timeout period.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. A client server system including a client apparatus and a server communicatable with this client apparatus via a network, wherein the client apparatus comprising:
a network controller for connecting the client apparatus to the server via the network; and
a control unit capable of executing check processing for the server, and
the control unit transmits, at the time of execution of the check processing for the server, a connection request packet to the server and performs port scan, checks a state of the server according to presence or absence of a response from the server, and, when there is no response, reports a connection error to a user after elapse of an arbitrary timeout period set in the client apparatus.

2. A client server system according to claim 1, wherein
the server has a service function according to a predetermined protocol,
the client apparatus is accessible to the server via the network controller, and
the control unit of the client apparatus transmits, at the time of the check processing for the server, a connection request packet to the server, scans a service port of the server to check whether the service port is opened, and, when it is determined that the service port is not opened, reports the connection error.

3. A client server system according to claim 1, wherein the control unit performs the port scan and, when it is confirmed that a predetermined service port of the server is opened, makes it possible to start communication of data with the server.

4. A client server system according to claim 1, wherein, when time required for checking in the case in which the check processing for the server is executed and the server functions normally is T1, the timeout period is set on the basis of the time T1.

5. A client server system according to claim 4, wherein, when a TCP is used as a protocol for the network, the timeout period set in the client apparatus is time independently set, which does not depend on a timeout period recommended by the TCP, and is changeable.

6. A client server system according to claim 1, wherein
the client apparatus further comprising an operation unit including a display device, and
the client apparatus reports, when there is no response from the server as a result of the check processing for the server, a connection error on the display device.

7. A client server system according to claim 6, wherein
the display device has a function of a touch panel, and
a button for executing the check processing for the server is displayed on the display device.

8. An image forming apparatus connectable to a server via a network, comprising:
an image-formation processing unit;
a network controller for connecting the image-formation processing unit to the server via the network; and
a control unit that controls an operation of the image-formation processing unit and is capable of executing check processing for the server, wherein
the control unit transmits, at the time of the check processing for the server, a connection request packet to the server and performs port scan, checks a state of the server according to presence or absence of a response from the server, and, when there is no response, reports a connection error to a user after elapse of an arbitrary timeout period set in the image forming apparatus.

9. An image forming apparatus according to claim 8, wherein the control unit performs the port scan to check whether a target service port of the server is opened and, when there is no response from the server, determines that the service port is not opened and reports the connection error.

10. An image forming apparatus according to claim 8, wherein the control unit performs the port scan and, when it is confirmed that a target service port of the server is opened, performs communication of data with the server.

11. An image forming apparatus according to claim 8, wherein, when time required for checking in the case in which the check processing for the server is executed and the server functions normally is T1, the timeout period is set on the basis of the time T1.

12. An image forming apparatus according to claim 8, further comprising an operation unit including a display device, wherein
the image forming apparatus reports, when there is no response from the server as a result of the check processing for the server, a connection error on the display device.

13. An image forming apparatus according to claim 12, wherein
the display device has a function of a touch panel, and
a button for executing the check processing for the server is displayed on the display device.

14. A server check method in an image forming apparatus having an image-formation processing unit and is capable of connecting the image-formation processing unit to a server via a network, the image forming apparatus being capable of executing check processing for the server,
the server check method comprising:
transmitting a connection request packet to the server and performing port scan at the time of execution of the check processing for the server;
checking a state of the server according to presence or absence of a response from the server; and
reporting, when there is no response, a connection error to a user after elapse of an arbitrary timeout period set in the image forming apparatus.

15. A server check method in an image forming apparatus according to claim 14, wherein
in checking a state of the server, the port scan is performed to check whether a target service port of the server is opened, and
when there is no response from the server, it is determined that the service port is not opened and the connection error is reported.

16. A server check method in an image forming apparatus according to claim 14, wherein
the image forming apparatus further includes an operation unit including a display device, and
when there is no response from the server as a result of the check processing for the server, a connection error is reported on the display device.

17. A server check method in an image forming apparatus according to claim 16, wherein
the display device has a function of a touch panel,
a button for executing the check processing for the server is displayed on the display device, and
the check processing for the server is started when the button is touched.

18. A server check method in an image forming apparatus according to claim 14, wherein, when time required for checking in the case in which the check processing for the server is executed and the server functions normally is T1, the timeout period is set on the basis of the time T1.
